(19) United States
(12) Patent Application Publication
(10) Pub. No.: US 2010/0144378 A1
(43) Pub. Date: Jun. 10, 2010

(54) REDUCING MESSAGING COSTS

(75) Inventors: Joseph Futty, Sammamish, WA (US); Danny Lange, Sammamish, WA (US); Fredrik Winsnes, Newcastle, WA (US); Chris Lwanga, Issaquah, WA (US); Bruce L. Johnson, Woodinville, WA (US); Bruce E. Johnson, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/329,394

(22) Filed: Dec. 5, 2008

(51) Int. Cl. H04W 4/14

(52) U.S. Cl. 455/466

(57) ABSTRACT

Technology for enabling subscribers to reduce their messaging costs is described. The technology includes employing multiple messaging data messaging services and employing advertisement-based defrayal of messaging charges. A message may be entered or displayed as an SMS message even though a data communications service other than SMS is used to exchange the message between computing devices. When a sender of a message sends an SMS message, the sender may receive an advertisement from an advertiser who defrays the cost of sending the SMS message. The advertiser may also defray the receiving cost for a receiver of the SMS message.

### BACKGROUND

Short Message Service (SMS) is a communications protocol that enables users of computing devices, such as mobile devices (e.g., cellular telephones), to exchange short messages (e.g., text messages). SMS messaging is a widely used communications application on mobile devices that generally enables users to send small messages. Some implementations of SMS enable users to send messages having up to 160 characters per message, though other implementations can enable users to send more or fewer characters per message. It is said that some children with mobile devices send hundreds of messages daily.

To send an SMS message, a message sender identifies a message recipient, inputs a message, and then sends the message. The sender may identify the recipient by a telephone number (“long code”) or a specified number (“short code”). An example of a short code is “*1234.” Some entities (e.g., television game or entertainment shows) may advertise a short code so that users can quickly send an SMS message without needing to send the message to a particular telephone number. A message recipient can merely reply to the message the recipient received without needing to specify the original sender's telephone number because the recipient's mobile device can store the sender's telephone number that was identified with the SMS message.

When subscribers exchange messages, the messages can transit intermediaries, such as store-and-forward servers, gateways, or other computing devices. For example, when a sender sends a message to a recipient, the message can be initially received by a computing device associated with the carrier whose services are subscribed to by the sender. The carrier's computing device may forward the message to a similar computing device operated by another carrier whose services the recipient subscribes to so that the recipient's carrier can deliver the message to the recipient.

Various mobile devices and carriers that enable data communications via the mobile devices provide data communications services other than SMS. An example of another data communications service is general packet radio service (GPRS). GPRS enables mobile devices to communicate using Internet Protocol (IP) and other data communications protocols. Applications can use GPRS to exchange data with other mobile devices as well as fixed devices (e.g., servers). For example, Instant Messenger applications, Internet browsing applications, and electronic mail applications can employ GPRS to exchange IP messages with other users and servers.

Carriers that provide voice and data communications services to mobile devices generally charge for sending SMS messages, receiving the messages, or both. The carriers may also charge different prices for the various data communications services they offer. For example, they may charge subscribers (e.g., users) $0.10 per SMS message and a much smaller amount (e.g., $0.01) for an equivalent IP message. The charges may also vary based on factors such as which carriers the senders and recipients of messages are associated with, the program or “plan” that the users have subscribed to, the time of day or day of week, and so forth. In some countries, sending and/or receiving SMS messages can be very expensive.

Even when a mobile device offers both SMS and one or more messaging applications based on alternative data communications capabilities (e.g., GPRS), users often prefer to use SMS because of familiarity, simplicity, ubiquity, or other factors. The users may use SMS to exchange messages even when sending or receiving SMS messages costs significantly more than messages that employ other data communications services.

### SUMMARY

Technology for enabling subscribers to reduce their messaging costs is described. The technology can employ multiple messaging data messaging services and employ advertisement-based defrayal of messaging charges. The technology can employ multiple messaging protocols to send or receive messages, but still provide the “look and feel” of SMS messaging. A sender can employ an SMS application to create and send a message to a designated recipient. The SMS application appends to the SMS message an indication of messaging capabilities available to the mobile device of the sender. The mobile device can determine capabilities based on various factors, such as what data communications services are available, what the costs of the services are, and so forth. Messages exchanged thereafter between the sender and recipient can employ a data communications service other than SMS to exchange subsequently sent messages (e.g., to reduce charges), but the exchanged messages may nevertheless be displayed or input using the SMS application.

An intermediary may send or append messages containing advertisements in exchange for defraying the costs of messages exchanged by users. Upon receiving the message, an advertiser or the intermediary can identify an advertisement to send to the sender and concurrently forward the message to the indicated recipient. The advertisement sent to the sender may be in a message separate from the message the sender sent. The advertiser may also send an advertisement to the recipient either with the forwarded message or as a separate message. The advertiser or intermediary can select an advertisement based on the sender's identity, recipient's identity, contents of the message, or other factors. Upon sending an advertisement to a subscriber, the carrier associated with the subscriber can credit the subscriber's account so that the message is sent or received at a defrayed cost.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating components employed in exchanging messages in various embodiments.

FIG. 2A is a block diagram illustrating components of a computing device in various embodiments.

FIG. 2B is a block diagram illustrating data networking services of a computing device in various embodiments.

FIGS. 3A and 3B are block diagrams illustrating a computing device and its user interface in various embodiments.

FIG. 4 is a flow diagram illustrating a routine invoked by a computing device to send a message in some embodiments.

FIG. 5 is a flow diagram illustrating a routine invoked by a computing device to receive a message in some embodiments.

FIG. 6 is a flow diagram illustrating a routine invoked by a computing device to receive a message in some embodiments.

FIG. 7 is a flow diagram illustrating a routine invoked by a computing device to collect messaging capabilities of a computing device in some embodiments.

FIG. 8 is a block diagram illustrating contents of a message in various embodiments.

FIG. 9 is a message flow diagram illustrating a flow if messages from a sender to a recipient via an intermediary in various embodiments.

FIG. 10 is a flow diagram illustrating a routine invoked by an intermediary to select an advertisement in some embodiments.

FIG. 11 is a table diagram illustrating a table of an intermediary for storing information that could be useful in selecting ads in some embodiments.

FIG. 12 is a flow diagram illustrating a routine invoked by a computing device to send a message in some embodiments.

### DETAILED DESCRIPTION

Technology for enabling subscribers to reduce their messaging costs is described. In various embodiments, the technology includes employing multiple messaging data messaging services and employing advertisement-based defrayal of messaging charges.

In various embodiments, the technology employs multiple messaging protocols to send or receive messages, but provides the “look and feel” of SMS messaging. A sender can employ an SMS application to create and send a message to a designated recipient. The SMS application appends to the SMS message an indication of messaging capabilities available to the mobile device of the sender. The mobile device can determine capabilities based on various factors, such as what data communications services are available, what the costs of the services are, and so forth. The capabilities can change, such as when the subscriber moves to a different geographical location or rates change based on day/time, and so forth. When the designated recipient receives the message, the SMS application executing on the recipient's mobile device can check whether the received message includes capabilities information. If the received message includes capabilities information, the recipient's SMS application can send corresponding capabilities information to the sender's mobile device. The recipient's capabilities information may be a subset of the sender's capabilities information. The recipient's SMS application can display the SMS message after stripping it of the sender's capabilities information. Messages exchanged thereafter between the sender and recipient can employ a data communications service other than SMS to exchange subsequently sent messages (e.g., to reduce charges), but the exchanged messages may nevertheless be displayed or input using the SMS application.

In various embodiments, an intermediary may send or append messages containing advertisements in exchange for defraying the costs of messages exchanged by users. As an example, when a sender desires to send a message to a recipient, the sender can indicate the recipient but send the message to an advertiser. Alternatively, the sender can indicate the recipient and the sender's SMS application can send the message to the advertiser; or the sender's carrier can route the message via an intermediary. Upon receiving the message, the advertiser or the intermediary can identify an advertisement to send to the sender and concurrently forward the message to the indicated recipient. The advertisement sent to the sender may be in a message separate from the message the sender sent. The advertiser may also send an advertisement to the recipient either with the forwarded message or as a separate message. The advertiser or intermediary can select an advertisement based on the sender's identity, recipient's identity, contents of the message, or other factors. In some embodiments, subscribers may choose to make available personal information in return for free messages. Examples of personal information may include Internet browser history, information accessed or content stored on the mobile device, and so forth. Upon sending an advertisement to a subscriber, the carrier associated with the subscriber can credit the subscriber's account so that the message was sent or received at a defrayed cost. The amount of defrayal can be a fraction of the message charge or its entire amount.

Several embodiments of the facility are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable media that may store instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

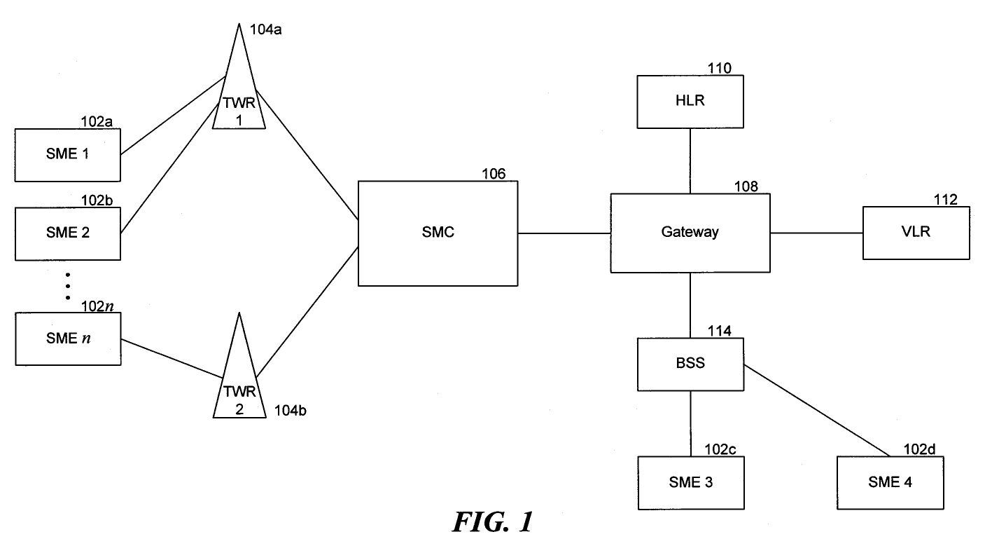

Turning now to the figures, FIG. 1 is a block diagram illustrating components employed in exchanging messages in various embodiments. The components include one or more short message entities (SME), such as SME1 102a, SME2 102b, SMEn 102n, SME 102c, and SME4 102d. An SME is a device (e.g., mobile phone or other computing device) that can send or receive messages, such as SMS messages. Each SME can connect with a base station system (BSS), such as BSS 114. A BSS can include a tower, such as tower1 104a and tower2 104b, so that the SMEs can exchange messages wirelessly, such as via one or more radio frequencies. A BSS can be associated with a short message center (SMC) 106 that may be configured to store and forward SMS messages. As an example, when SME1 102a sends an SMS message to SME2 102b, SMC 106 can store the message SME 1 102a sent and then forward the message to SME2 102b (e.g., when SME2 102b is available to receive a message). When a sender SME affiliated with a first carrier sends a message to a recipient SME that is affiliated with a second, different carrier, the SMC 106 of the first carrier may employ a gateway 108 to forward the message to the second carrier. The gateway can employ the services of a home location register (HLR) 110 to identify the second carrier with which the recipient SME is affiliated. The gateway may employ the services of a mobile switching center (not illustrated) to switch connections between SMEs or between SMEs and other devices of the carrier's network. The gateway or mobile switching center can employ the services of a visitor location register (VLR) to provide/store information relating to visiting SMEs (e.g., “roaming” mobile telephones). Thus, when a computing device (e.g., SME) sends a message to another computing device, several intermediaries (e.g., other computing devices) may handle the message. These other computing devices can merely route and/or forward the messages, or can modify the messages in some way.

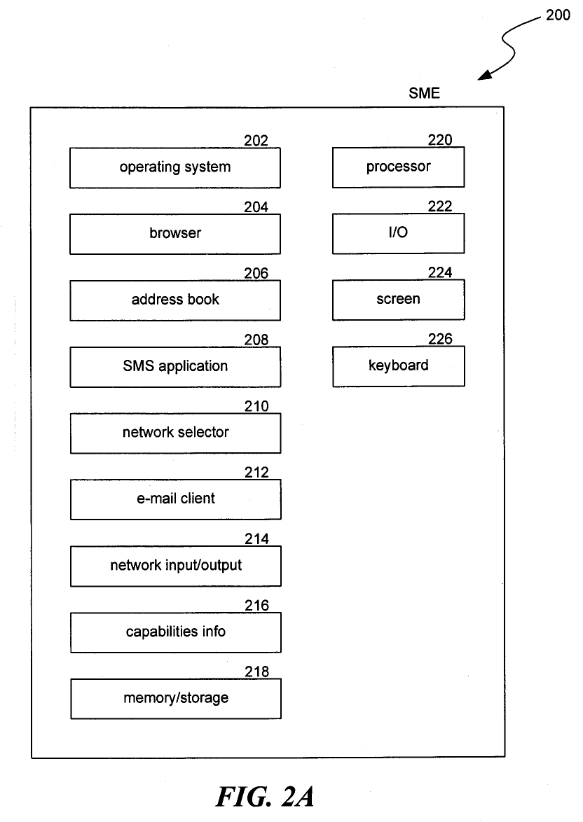

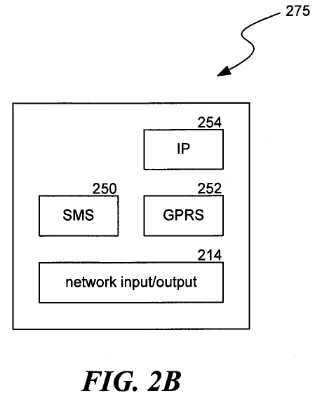

FIG. 2A is a block diagram illustrating components of a computing device in various embodiments. The computing device (e.g., SME) 200 can include an operating system 202, an Internet browser 204, an address book 206, an SMS application 208, a network selector 210, an e-mail client 212, a network input/output component 214, a capabilities information component 216, a memory/storage component 218, a processor 220, an input/output component 222, a screen 224, and a keyboard 226. One skilled in the art will recognize that various forms of input and output are possible. As examples, the computing device may receive input from a keyboard, a stylus, a touchscreen, voice, or other means.

FIG. 2B is a block diagram illustrating data networking services of a computing device in various embodiments. The illustrated networking components 275 include a network input/output component 214, an SMS data networking service 250, a GPRS networking service 252, and an IP networking service 254. Other networking services are also possible, such as 3G, 4G, high-speed packet access (HSPA), EVDO, UMTS, and so forth.

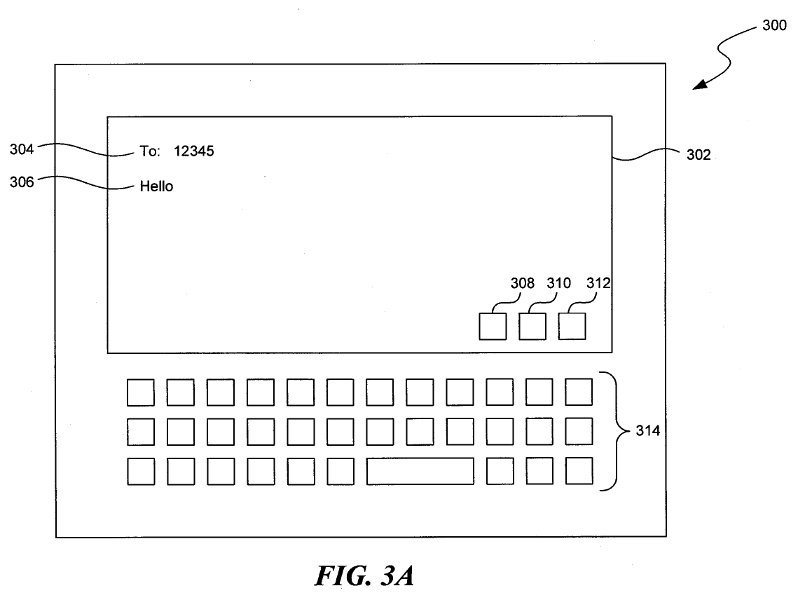

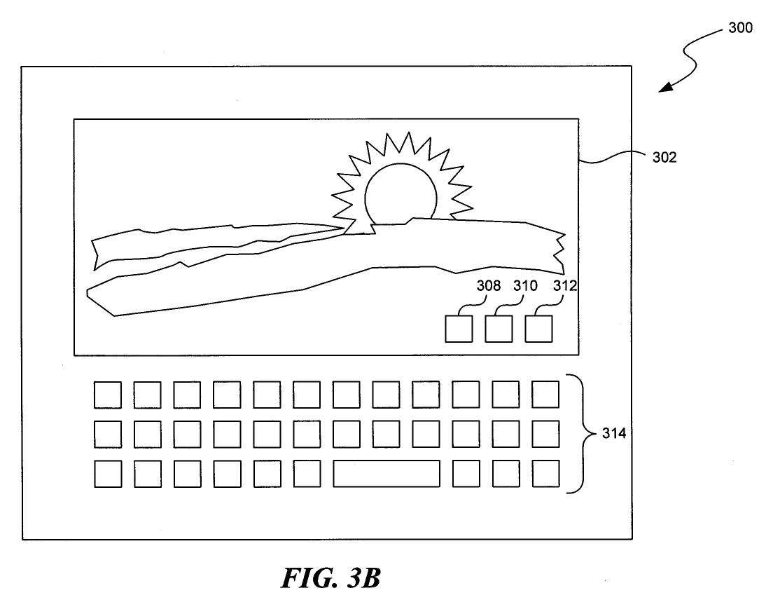

FIGS. 3A and 3B are block diagrams illustrating a computing device and its user interface in various embodiments. According to the illustration in FIG. 3A, a computing device 300 can be a mobile computing device, such as a cellular telephone. The computing device 300 includes a screen 302 and a keyboard 314. A user can employ the keyboard 314 to enter a text message, such as an SMS message. According to the illustration, the user has created a text message and has identified phone number 12345 as a recipient 304. The user has also input the word “Hello” as the text message 306. The screen 302 may also provide various indications, such as indications 308, 310, and 312. The indications may indicate that data networking is available or that a reduced-fee-for-messaging user's non-roaming carrier coverage area. The screen 302 can also display images, as is illustrated in FIG. 3B.

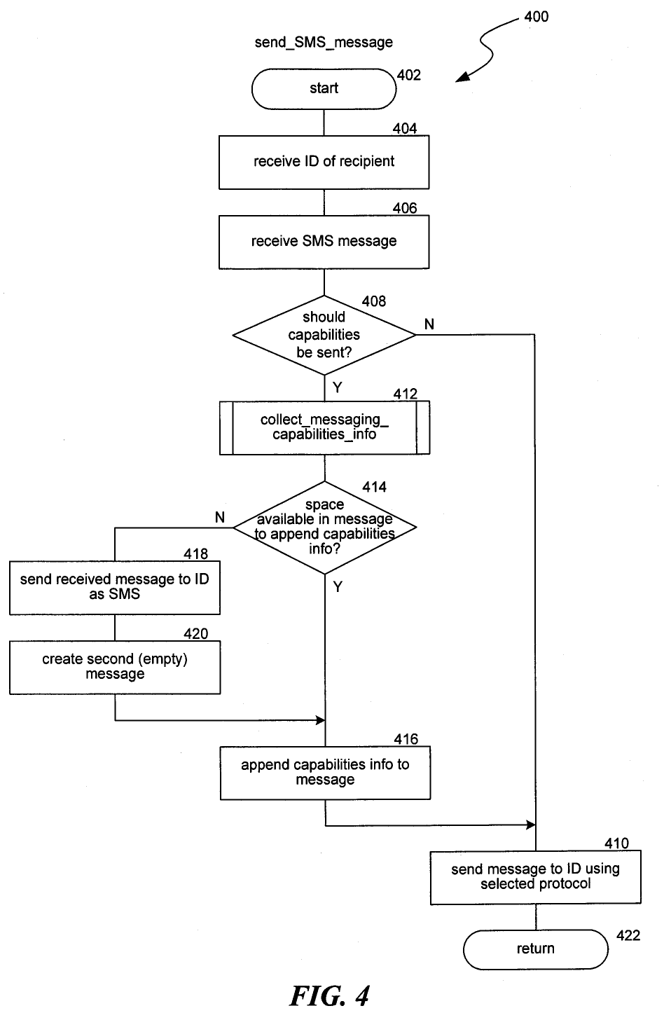

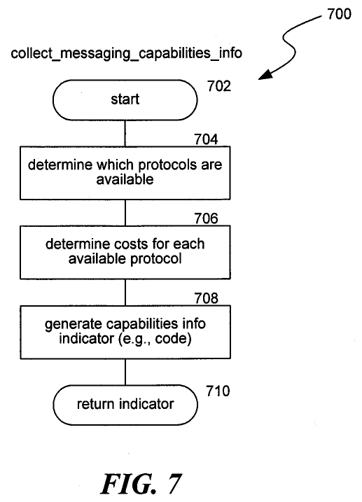

FIG. 4 is a flow diagram illustrating a routine invoked by a computing device to send a message in some embodiments. The SMS application may invoke the send_SMS_message routine 400 when sending an SMS message. The routine begins at block 402. At block 404, the routine receives an identifier for a recipient of the message. As an example, the routine may receive a phone number (long code) or short code to which the message should be sent. At block 406, the routine receives the contents of the message, such as text. At decision block 408, the routine determines whether messaging capabilities information has already been sent or should be sent. Messaging capabilities information includes information such as which data communications services are available, which ones are lower-cost, etc. Messaging capabilities information may need to be sent if the information has not previously been sent or some threshold period of time has elapsed since the information was previously sent. If capabilities information does not need to be sent, the routine continues at block 410. Otherwise, the routine continues at block 412. At block 412, the routine invokes a collect_messaging_capabilities_information subroutine to collect messaging capabilities of the mobile device. The collect_messaging_capabilities_information subroutine is described in further detail below in relation to FIG. 7. At decision block 414, the routine determines whether there is sufficient space in the message to be sent to the recipient to append the collected messaging capabilities information. If there is sufficient space, the routine continues at block 416. Otherwise, the routine continues at block 418. At block 416, the routine appends the collected capabilities information to the message and then continues at block 410.

At block 418, the routine sends the received message to the identified message recipient as an SMS message. The routine then creates at block 420 a second, empty message and then continues at block 416 to add the collected messaging capabilities information to the empty message. The routine then continues at block 410.

At block 410, the routine sends the message to the identified recipient. If a data communications service (e.g., a protocol) other than SMS has not yet been negotiated with the recipient computing device, the routine sends the message as an messaging capabilities information to the empty message. The routine then continues at block 410.

At block 410, the routine sends the message to the identified recipient. If a data communications service (e.g., a protocol) other than SMS has not yet been negotiated with the recipient computing device, the routine sends the message as an SMS message to the recipient computing device. Otherwise, the routine employs the selected data communications service to send the message to the recipient computing device. The routine then returns at block 422.

Those skilled in the art will appreciate that the logic illustrated in FIG. 4 and described above, and in each of the flow diagrams discussed below, may be altered in a variety of ways. For example, the order of the logic may be rearranged, substeps may be performed in parallel, illustrated logic may be omitted, other logic may be included, etc.

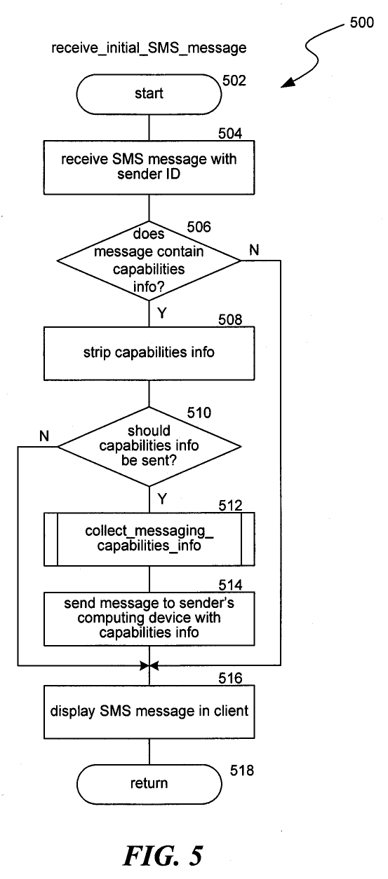

FIG. 5 is a flow diagram illustrating a routine invoked by a computing device to receive a message in some embodiments. The SMS application may invoke the receive_initial_SMS_message routine 500 when it first receives an SMS message. In some embodiments, the SMS application may invoke the receive_initial_SMS_message routine 500 every time it receives an SMS message. The routine begins at block 502. At block 504, the routine receives an SMS message that also indicates an identifier for the sender (e.g., originator) of the message. At decision block 506, the routine determines whether the received message contains capabilities information. The capabilities information may be indicated as a code along with a delimiter between the message contents and the code. An example of a delimiter is “@@.” One skilled in the art will recognize that other delimiters are possible. If the received message contains capabilities information, the routine continues at block 508 to strip the capabilities information for further processing. At decision block 510, the routine determines whether the recipient computing device should send messaging capabilities information to the sender computing device. The messaging capabilities information may need to be sent if it was not previously sent or some threshold period of time has elapsed since it was previously sent. If the messaging capabilities information should be sent, the routine continues at block 512. Otherwise, the routine continues at block 516 because the message sender's computing device did not send messaging capabilities information and so probably is using a “legacy” SMS application that is unable to negotiate a communications service offering lower cost. At block 512, the routine collects messaging capabilities information (e.g., by invoking the subroutine described below in relation to FIG. 7) and then at block 514 sends a message to the message sender's computing device with the collected capabilities information. At block 516, the routine displays the received SMS message content in an SMS client, such as the SMS application. The routine then returns at block 518.

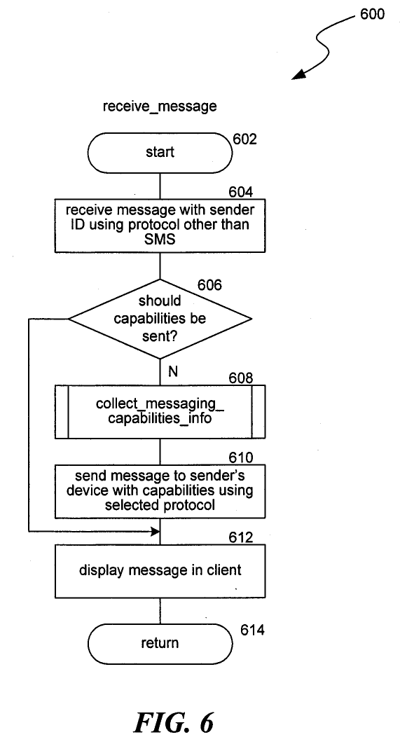

FIG. 6 is a flow diagram illustrating a routine invoked by a computing device to receive a message in some embodiments. The SMS application may invoke the receive_message routine 600 when it receives a message using a data communications service other than SMS (e.g., IP). The routine begins at block 602. At block 604, the routine receives a message in a protocol other than SMS. As an example, the routine may receive the message via GPRS. The message may indicate an identifier for the sender of the message. At decision block 606, the routine determines whether messaging capabilities information should be sent to the sender of the message. The messaging capabilities information may need to be sent if it was not previously sent or some threshold period of time has elapsed since it was previously sent. If the messaging capabilities information should be sent, the routine continues at block 608. Otherwise, the routine continues at block 612. At block 608, the routine collects messaging capabilities information (e.g., by invoking the subroutine described below in relation to FIG. 7) and then at block 610 sends a message to the message sender's computing device with the capabilities information. At block 612, the routine displays the received message in a client, such as the SMS application. Thus, even though the message was received via a data communications service (e.g., protocol) other than SMS, the technology displays the received message in a client that looks to the user to be an SMS application. The routine then returns at block 614.

FIG. 7 is a flow diagram illustrating a routine invoked by a computing device to collect messaging capabilities of a computing device in some embodiments. Various routines invoke the collect_messaging_capabilities_information routine 700 to collect messaging capabilities of the computing device. The routine begins at block 702. At block 704, the routine determines which data communications services (e.g., protocols) are available. As examples, the routine may determine that SMS and GPRS are available but EVDO is not available from the carrier even though the computing device is capable of exchanging messages using EVDO. At block 706, the routine determines cost for each available data communications service. The routine may make this determination based on stored information, user preferences, or by dynamically querying a server, such as a server provided by the user's carrier or a third party. The routine may then determine which of the available data communications services should be advertised to other computing devices. At block 708, the routine may then generate a capabilities information indicator, such as a code. The code may be a few characters long so as not to occupy a large portion of an SMS message payload. At block 710, the routine returns the generated indicator.

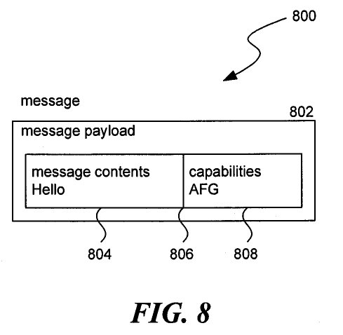

FIG. 8 is a block diagram illustrating contents of a message in various embodiments. A message 800 can include a message payload 802. The message payload can have a message contents section 804 and a messaging capabilities indicator (e.g., code) 808. The message payload 802 may also have a delimiter 806 that enables a client (e.g., SMS application) to distinguish between message contents input by a user and messaging capabilities indicator generated by the technology and added to the message automatically. Examples of delimiters are “$$,” “@@,” and so forth. In the illustrated example, the message payload may be “Hello@@AFG” wherein the user-entered contents are Hello and the code is AFG.

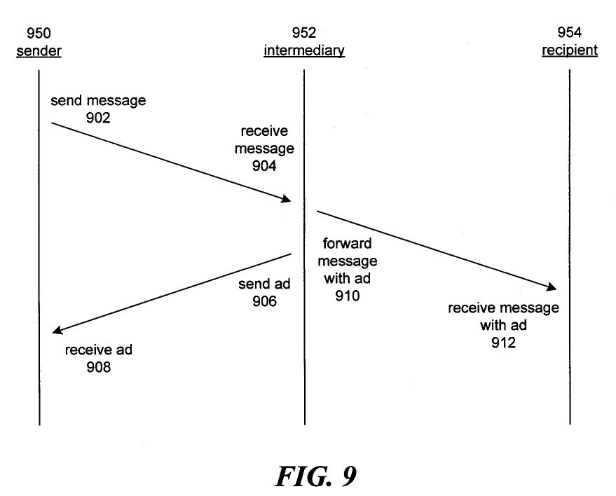

Turning now to the advertising model, FIG. 9 is a message flow diagram illustrating a flow if messages from a sender to a recipient via an intermediary in various embodiments. A message sender computing device 950 sends a message 902 by identifying a recipient computing device 954. The message may transit one or more intermediaries 952. When the intermediary 952 receives a message 904, it may select an advertisement to send to the message sender 950 and send that advertisement 906 to the message sender so that the message sender can receive and view the advertisement 908. The intermediary 952 may also forward the received message 910 to the message recipient 954. The intermediary may insert an advertisement when forwarding the message to the identified recipient 954. In various embodiments, the advertisement sent to the sender 950 may be different from the advertisement sent to the recipient 954. In various embodiments, the intermediary 952 can be a computing device operated by a carrier, advertiser, or other entity.

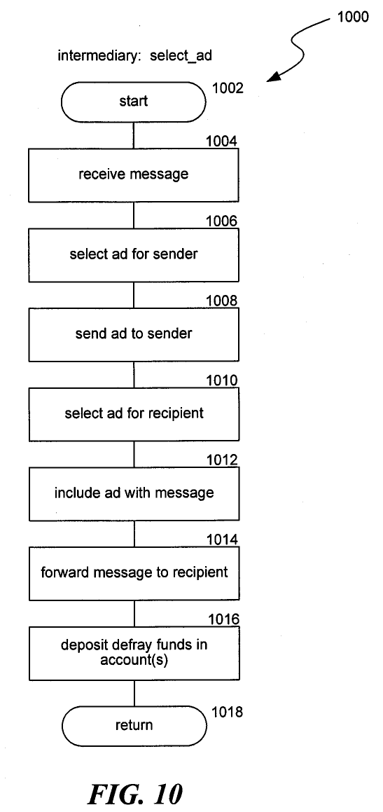

FIG. 10 is a flow diagram illustrating a routine invoked by an intermediary to select an advertisement in some embodiments. The intermediary may invoke the select_ad routine 1000 to select an advertisement when handling messages. The routine begins at block 1002. At block 1004, the routine receives a message. At block 1006, the routine selects an advertisement for the sender of the message. At block 1008, the routine sends the selected advertisement to the sender as a message. At block 1010, the routine selects an advertisement for the recipient of the previously received message. At block 1012, the routine appends the selected advertisement to the message to be forwarded. At block 1014, the routine then forwards the appended message to the identified recipient. In various embodiments, the routine may send the advertisement to the recipient as a separate message or may not send the advertisement to the recipient at all. The intermediary may defray the cost of the messages after sending advertisements, such as by crediting the user's account at the user's carrier at block 1016. In various embodiments, the select_ad routine can select advertisements based on identity of the sender, identity of the recipient, message contents, personal information previously collected about the sender or recipient, and so forth. The routine returns at block 1018.

In various embodiments, the sender can send the message to the recipient as the sender would normally or the sender can send the message to a designated telephone number or short code identifying the advertiser or entity that defrays costs. When sending the message to the advertiser or other entity, the sender can identify the actual recipient by providing the recipient's phone number as the first few characters of the SMS message. The advertiser or entity that defrays costs can then strip those characters from the SMS message to actually forward the message to the identified recipient.

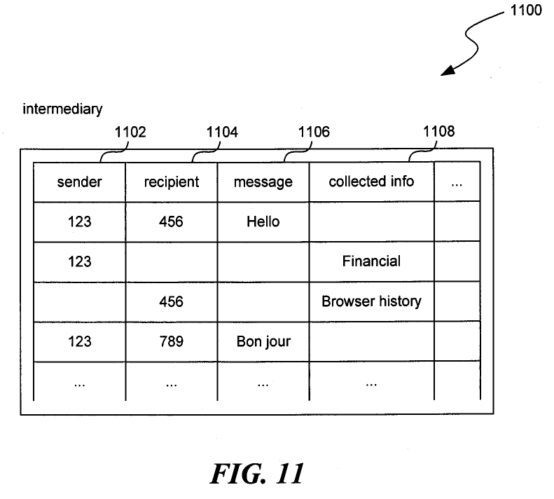

FIG. 11 is a table diagram illustrating a table of an intermediary for storing information that could be useful in selecting ads in some embodiments. The table 1100 can be stored by an intermediary locally or remotely. The table can include a sender column 1102, recipient column 1104, message column 1106, and collected information column 1108. The information stored in the table indicates that phone number 123 sent a message to phone number 456 containing contents “Hello”; financial information is stored with respect to phone number 123; browser history is stored with respect to phone number 456; and so forth.

While FIG. 11 illustrates a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

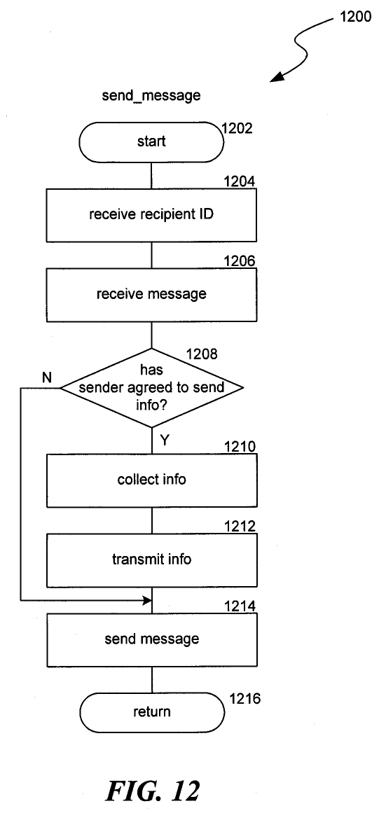

FIG. 12 is a flow diagram illustrating a routine invoked by a computing device to send a message in some embodiments. A computing device may invoke the send_message routine 1200 when sending personal information (e.g., financial, information, browser history, other locally stored information, etc.). The routine begins at block 1202. At block 1204, the routine receives an identifier for a recipient of the message. At block 1206, the routine receives the message (e.g., message contents). At decision block 1208, the routine determines whether the sender has authorized the computing device to send personal information. If the sender has authorized the computing device to send personal information, the routine continues at block 1210. Otherwise, the routine continues at block 1214. At block 1210, the routine collects personal information from the computing device. At block 1212, the routine transmits the personal information. An intermediary may be able to use the personal information to select an advertisement that is more targeted at the sender. At block 1214, the routine sends the message. At block 1216, the routine returns.

Various alternative embodiments of the technology will now be described. It is to be understood that the described embodiments can be combined in various ways as would be apparent to one skilled in the art.

In various embodiments, the technology includes a system for reducing messaging costs. The system can comprise a computing device having a processor and memory, the memory storing one or more components implemented in software. The components can comprise an SMS application that is configured to collect messaging capabilities of the computing device, append to a first message input by a user a code indicating at least a subset of the collected messaging capabilities, and transmit the appended message as a SMS message to a recipient computing device. The SMS application can receive a second message input by the user and transmit the second message using a data communications service other than SMS if the recipient computing device that responded to the previously transmitted SMS message with a code indicating that the recipient computing device is capable of exchanging messages using the data communications service other than SMS. The data communications service other than SMS can be indicated as an available messaging capability by the collected messaging capabilities of the computing device.

The system can also include a component that is configured to determine capabilities information for the computing device, such as a data communications service. As an example, the component can identify GPRS or IP as an available capability. The data communications service can be indicated as available if a carrier whose services the computing device employs charges a lower price for sending the first message using the capability than for sending the first message using the SMS message. The system can also include a network selector that is configured to select a data communications service for sending the first message wherein the selected data communications service is not SMS even though the user employed the SMS application to input the first message. The system can include an input/output component that transforms physical input received from a user (e.g., via keyboard, stylus, voice, pointing device, etc.) into a message (e.g., a text message). Although the messages can be text messages, graphics messages, or other types of messages, most SMS users generally send text messages.

In various embodiments, the technology includes one or more computer-readable storage media collectively storing computer-executable instructions that, when executed, cause a computing system to perform a method for reducing messaging costs. The instructions can include receiving a message from a sender computing device, the message identifying the sender, a recipient, and content; identifying from a set of advertisements a first advertisement; sending to the sender computing device a message including the first advertisement; depositing in a sender account an amount of money; and forwarding the received message to a recipient computing device associated with the identified recipient. The instructions can also include receiving from the sender computing device information personal to the sender stored at the sender information device. The information personal to the sender stored at the sender information device can be Internet browser history or other personal information. The sender can indicate whether or not the personal information should be made available. Similar information can also be made available by the recipient. When the personal information is made available, an advertiser or intermediary that selects advertisements can more precisely select ads that may be relevant. The amount of money can defray a cost incurred by the sender to send the message and/or the recipient to receive the message. The amount defrayed can be a portion or the entirety of the amount charged by the respective carrier. The message can be a text message. When a user provides input that is transformed into a text message, the text message can be temporarily stored as a document in storage (e.g., memory) before it is transmitted or forwarded. The instructions can also include selecting a second advertisement and transmitting the selected second advertisement to the recipient computing device. The second advertisement can be included in the forwarded message or transmitted separately to the recipient. The advertisements can be selected based on one or more of the following: the identity of the sender, the identity of the recipient, the content, or previously sent information personal to either the identified sender or the identified recipient.

In various embodiments, the technology invokes a method performed by a computing system for reducing messaging costs. The method comprises receiving at a recipient computing device a first message, the first message received as an SMS message indicating messaging capabilities of a sender computing device; collecting at the recipient computing device messaging capabilities of the recipient computing device; transmitting from the recipient computing device at least a subset of the collected messaging capabilities of the recipient computing device to the sender computing device, the messaging capabilities including a capability to receive messages using a data communications service other than SMS; receiving at the recipient computing device a second message, the second message received using the data communications service other than SMS; and displaying content received in the second message using an SMS application. The method can also include stripping from the first message a content and a code, the code indicating the messaging capabilities of the sender computing device; and displaying the content stripped from the first message using the SMS application. The collecting can comprise selecting messaging capabilities based on the indicated messaging capabilities of the sender computing device and a cost associated with the selected messaging capabilities.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A system for reducing messaging costs, comprising:
a computing device having a processor and memory, the memory storing one or more components implemented in software, the components comprising:
an SMS application configured to collect messaging capabilities of the computing device, append to a first message input by a user a code indicating at least a subset of the collected messaging capabilities, and transmit the appended message as a SMS message to a recipient computing device.

2. The system of claim 1 wherein the SMS application is further configured to receive a second message input by the user and transmit the second message using a data communications service other than SMS if the recipient computing device that responded to the previously transmitted SMS message with a code indicating that the recipient computing device is capable of exchanging messages using the data communications service other than SMS, wherein the data communications service other than SMS is indicated as an available messaging capability by the collected messaging capabilities of the computing device.

3. The system of claim 1 further comprising a component that is configured to determine capabilities information for the computing device.

4. The system of claim 1 further comprising a component that determines capabilities information for the computing device wherein a capability is a data communications service.

5. The system of claim 1 further comprising a component that is configured to determine capabilities information for the computing device wherein a capability is a data communications service and the capability is available if a carrier whose services the computing device employs charges a lower price for sending the first message using the capability than for sending the first message using the SMS message.

6. The system of claim 1 further comprising a network selector that is configured to select a data communications service for sending the first message wherein the selected data communications service is not SMS even though the user employed the SMS application to input the first message.

7. The system of claim 1 further comprising an input/output component that transforms physical input received from a user into a message.

8. The system of claim 1 wherein the first message is a text message.

9. One or more computer-readable storage media collectively storing computer-executable instructions that, when executed, cause a computing system to perform a method for reducing messaging costs, the instructions comprising:
receiving a message from a sender computing device, the message identifying the sender, a recipient, and content;
identifying from a set of advertisements a first advertisement;
sending to the sender computing device a message including the first advertisement;
depositing in a sender account an amount of money; and
forwarding the received message to a recipient computing device associated with the identified recipient.

10. The computer-readable storage medium of claim 9 further comprising instructions for receiving from the sender computing device information personal to the sender stored at the sender information device.

11. The computer-readable storage medium of claim 9 wherein the information personal to the sender stored at the sender information device is Internet browser history.

12. The computer-readable storage medium of claim 9 wherein the amount of money defrays a cost incurred by the sender to send the message.

13. The computer-readable storage medium of claim 9 wherein the message is a text message that is stored as a document in a memory.

14. The computer-readable storage medium of claim 9 further comprising instructions for selecting a second advertisement and transmitting the selected second advertisement to the recipient computing device.

15. The computer-readable storage medium of claim 9 wherein the second advertisement is included in the forwarded message.

16. The computer-readable storage medium of claim 9 wherein the second advertisement is sent to the recipient computing device as a message other than the forwarded message.

17. The computer-readable storage medium of claim 9 wherein the first advertisement is selected based on at least one of: the identified sender, identified recipient, identified content, or previously sent information personal to either the identified sender or the identified recipient.

18. A method performed by a computing system for reducing messaging costs, comprising:
receiving at a recipient computing device a first message, the first message received as an SMS message indicating messaging capabilities of a sender computing device;
collecting at the recipient computing device messaging capabilities of the recipient computing device;
transmitting from the recipient computing device at least a subset of the collected messaging capabilities of the recipient computing device to the sender computing device, the messaging capabilities including a capability to receive messages using a data communications service other than SMS;
receiving at the recipient computing device a second message, the second message received using the data communications service other than SMS; and
displaying content received in the second message using an SMS application.

19. The method of claim 18 further comprising:
stripping from the first message a content and a code, the code indicating the messaging capabilities of the sender computing device; and
displaying the content stripped from the first message using the SMS application.

20. The method of claim 18 further wherein the collecting comprises selecting messaging capabilities based on the indicated messaging capabilities of the sender computing device and a cost associated with the selected messaging capabilities.
